(19) United States
(12) Patent Application Publication
(10) Pub. No.: US 2005/0185905 A1
(43) Pub. Date: Aug. 25, 2005

(54) Dispersion correction fiber, transmission system and method of operating same

(76) Inventors: James P. Burke, Huntsville, AL (US); George E. Berkey, Pine City, NY (US); Dmitri V. Kuksenkov, Painted Post, NY (US); Ming-Jun Li, Horseheads, NY (US); Daniel A. Nolan, Corning, NY (US); William A. Wood, Painted Post, NY (US)

Correspondence Address: CORNING INCORPORATED, SP-TI-3-1, CORNING, NY, 14831, US

(21) Appl. No.: 11/057,313

(22) Filed: Feb. 11, 2005

Related U.S. Application Data
(60) Provisional application No. 60/546,487, filed on Feb. 20, 2004.

(51) Int. Cl. G02B 6/16

(52) U.S. Cl. 385/123; 385/127

(57) ABSTRACT

A dispersion correction optical fiber includes a segmented core having a central core segment, a moat segment and, preferably, a ring segment. The refractive index profile is selected to provide a total dispersion minimum which is located within an operating wavelength band of the fiber. Most preferably, the dispersion value at the minimum is more negative than −400 ps/nm/km and greater than −1200 ps/nm/km at 1550 nm. Optical transmission systems including the present invention dispersion correction optical fiber optically coupled to various transmission fibers and dispersion compensating fibers are also disclosed, as is a method of operating the dispersion correction fiber wherein the minimum is located within the desired operating wavelength band.

### CROSS-REFERENCE TO RELATED APPLICATIONS

This application claims the benefit of priority under 35 U.S.C. § 119(e) of U.S. Provisional Application Ser. No. 60/546,487 filed on Feb. 20, 2004.

### BACKGROUND OF THE INVENTION

1. Field of the Invention

The present invention relates generally to optical fiber, and more particularly to a dispersion correction fiber for use with a dispersion compensating fiber to reduce residual dispersion in a optical transmission span and systems including the same.

2. Technical Background

Higher bit transmission rates have resulted in a large demand for optical transmission systems that can control and minimize dispersion effects. Analysis of common optical transmission systems indicates that while optical transmission systems can tolerate fairly large amounts of residual dispersion at 10 Gbit/second, these systems can tolerate only small amounts of residual dispersion at higher transmission rates of about 40 Gbit/second without causing unwanted signal distortion. Therefore, it is important to accurately control dispersion in such high bit-rate optical transmission systems across the entire wavelength band of interest.

Conventional two-fiber dispersion compensated systems include a transmission fiber generally having positive dispersion at 1550 nm serially optically coupled to a dispersion compensating fiber having negative dispersion at 1550 nm, wherein the dispersion compensating fiber compensates for accumulated dispersion within the span. The length of the dispersion compensating fiber is chosen such that the dispersion is approximately zero at the end of the span. Examples of such dispersion compensating fibers and systems may be found in U.S. Pat. Nos. 5,361,319 and 6,349,163.

In attempts to achieve even higher levels of dispersion correction, certain three fiber solutions have been employed wherein dispersion of a transmission fiber is compensated for by a combination of a dispersion compensating fiber serially coupled to a third fiber (referred to as a correction fiber or trim fiber). Examples of such three fiber solutions having a correction fiber may be found in US 2003/0039435; US 2002/0102084; and 2003/0091309. Although such systems have improved overall residual dispersion as compared to conventional two-fiber dispersion compensation techniques, improvements further reducing span residual dispersion across the operating wavelength band of interest are needed.

Thus, there is a need for an fiber, or combinations thereof, useful for compensating accumulated dispersion in optical transmission spans which overcomes the problem associated with the prior art.

### SUMMARY OF THE INVENTION

Definitions:

The following definitions and terminology are commonly used in the art.

Refractive index profile—The refractive index profile is the relationship between the relative refractive index (Δ %) and the optical fiber radius in microns (as measured from the centerline (CL) of the optical fiber).

Segmented core—A segmented core is one that includes multiple segments in the physical core, such as a first and a second segment, for example, including any two of the following: a central core segment, a moat segment, and a ring segment. Each segment has a respective relative refractive index profile having maximum and minimum relative refractive indices therein.

Effective area—The effective area is defined as:
A_{eff}=2π(∫E²rdr)²/(∫E⁴rdr),
wherein the integration limits are 0 to ∞, and E is the electric field associated with the propagated light as measured at 1550 nm.

Relative refractive index percent Δ %—The term Δ % represents a relative measure of refractive index defined by the equation:
Δ %=100×(nᵢ²−n_{c}²)/2nᵢ²
where nᵢ is the maximum (or minimum in the case of a moat) refractive index of the index profile segment measured relative to the refractive index of the clad layer n_{c}.

Alpha-profile—The term alpha-profile refers to a shape of the relative refractive index profile of the central core segment expressed in terms of Δ(b) % where b is the radius, and which follows the equation:
Δ(b) %={Δb₀(1−[|b−b₀|/(b₁−b₀)]^{a}}×100,
where b₀ is the maximum point of the profile of the core and b₁ is the point at which Δ(b) % is zero and b is the range of bᵢ less than or equal to b less than or equal to b_{f}, where Δ % is defined above, bᵢ is the initial point of the alpha-profile, b_{f} is the final point of the alpha-profile, and alpha is an exponent which is a real number. The central core segment profile may include an offset in that the radius b₀ may start at a point which is offset from the fiber's centerline.

Pin array macro-bending test—This test is used to test compare relative resistance of optical fibers to macro-bending. To perform this test, attenuation loss is measured at 1550 nm when the optical fiber is arranged such that no induced bending loss occurs. This optical fiber is then woven about the pin array and attenuation again measured at the same wavelength. The loss induced by bending is the difference between the two attenuation measurements (in dB). The pin array is a set of ten cylindrical pins arranged in a single row and held in a fixed vertical position on a flat surface. The pin spacing is 5 mm, center-to-center. The pin diameter is 0.67 mm. The optical fiber is caused to pass on opposite sides of adjacent pins. During testing, the optical fiber is placed under enough tension sufficient to make to the optical fiber conform to a portion of the periphery of the pins.

Minimum—Minimum, as used herein, refers to the mathematical minimum, i.e., the point of lowest dispersion in the wavelength band of the dispersion plot of dispersion versus wavelength where the dispersion slope is zero.

According to embodiments of the invention, a single core dispersion correction fiber is provided comprising a refractive index profile selected to provide a dispersion minimum having a negative value, the dispersion minimum being located within a wavelength band between 1460 and 1625 nm. Preferably, the value of total dispersion, in the LP₀₁ mode, at the minimum is less than −400 ps/nm/km, more preferably less than −600 ps/nm/km, and is likewise preferably greater than −1,200 ps/nm/km. Preferably also, the minimum is located within the operating wavelength band of the system in which it is deployed. In several embodiments, the dispersion minimum is located within the C-operating wavelength band (between 1530 and 1565 nm) thereby allowing for excellent dispersion compensation across the C-band.

According to further aspects of the invention, an optical fiber transmission line is provided comprising a transmission fiber having positive dispersion within an operating wavelength band; a dispersion compensating fiber having a negative dispersion within the wavelength band optically coupled to the transmission fiber; and the dispersion correction fiber optically coupled to the dispersion compensating fiber, the dispersion correction fiber having a dispersion minimum with a negative total dispersion at the minimum, and in the LP₀₁ mode, wherein the dispersion minimum is located within the operating wavelength band which is between 1460 and 1625 nm and wherein within the operating wavelength band, the transmission line exhibits a residual dispersion less than +/−10 ps/nm per 100 km span of the transmission fiber (more preferably less than +/−5 ps/nm per 100 km span). Preferably, the total dispersion at the minimum of less than −400 ps/nm/km. The minimum is preferably located at a wavelength that substantially corresponds (preferably within +/−10 nm of) with the location of the maximum in the plot of combined accumulated dispersion for the transmission fiber and dispersion compensating fiber for the span.

In accordance with a further aspect of the invention, a method of operating a dispersion correction fiber within an optical transmission system is provided, wherein the method comprises the steps of providing a dispersion correction fiber within an optical transmission system, the dispersion correction fiber having a dispersion minimum in the LP₀₁ mode, and operating the optical transmission system within an operating wavelength band wherein the dispersion minimum is positioned within the operating wavelength band. Most preferably, the dispersion correction fiber is selected to have a total dispersion value at the minimum, in the LP₀₁ mode, of between −400 ps/nm/km and −1,200 ps/nm/km; and more preferably more negative than −600 ps/nm/km. In operation, the dispersion correction fiber is optically coupled to a transmission fiber and a dispersion compensation fiber within the optical transmission system. Preferably, the curvature of the dispersion plot (dispersion versus wavelength) of the correction fiber is selected such that it substantially mirrors the residual dispersion plot of the combined accumulated dispersion of the transmission fiber and dispersion compensating fiber at the end of that concatenated span. In particular, the minimum location should align (within +/−10 nm) with the location of the maxima in the combined accumulated dispersion plot. Preferably, the optical transmission system exhibits a residual dispersion less than +/−10 ps/nm per 100 km span of the transmission fiber; and more preferably less than +/−5 ps/nm per 100 km span. In accordance with preferred embodiments, the transmission fiber exhibits dispersion between 2 and 20 ps/nm/km at 1550 nm, and the dispersion compensating fiber has a dispersion of between −80 and −170 ps/nm/km at 1550 nm. Embodiments are disclosed herein which are suitable for correcting the residual dispersion of systems including low dispersion NZDSF (Dispersion=2-5 ps/nm/km at 1550 nm), moderate dispersion NZDSF (Dispersion=6-14 ps/nm/km at 1550 nm), and standard single mode fiber (Dispersion=15-20 ps/nm/km at 1550 nm)

Preferably, the dispersion correction fiber in accordance with the invention is serially optically coupled to a dispersion compensating fiber and is included within a dispersion compensating module.

Additional features and advantages of the invention will be set forth in the detailed description which follows, and in part will be readily apparent to those skilled in the art from that description or recognized by practicing the invention as described herein, including the detailed description which follows, the claims, as well as the appended drawings. It is to be understood that both the foregoing general description and the following detailed description present embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention and together with the description serve to explain the principles and operations of the invention.

### BRIEF DESCRIPTION OF THE DRAWINGS

FIGS. 1 and 2 are schematic views of three-fiber optical transmission systems including the dispersion correction fiber in accordance with embodiments of the present invention.

FIG. 3 is a cross-sectioned isometric view of the multi-segmented dispersion correction fiber in accordance with embodiments of the invention.

FIG. 4 is a plot of a representative relative refractive index profile (Delta % vs. Radius (μm)) for a first embodiment of the dispersion correction fiber in accordance with the invention.

FIG. 5 is a graph of dispersion (ps/nm/km) versus wavelength (nm) for the dispersion correction fiber according to FIG. 4 illustrating the designed location and value of the dispersion minimum within an operating wavelength band.

FIG. 6 is a graph of accumulated dispersion (ps/nm) versus wavelength (nm) for the various fibers including the dispersion correction fiber of FIG. 4 and combinations of fibers in the system over an operating wavelength band.

FIG. 7 is a graph of dispersion (ps/nm/km) versus wavelength (nm) for several dispersion correction fibers illustrating how the designed location of the dispersion minimum may be adjusted.

FIG. 8 is a plot of a representative relative refractive index profile (Delta % vs. Radius (μm)) for a second embodiment of the dispersion correction fiber in accordance with the invention.

FIG. 9 is a graph of dispersion (ps/nm/km) versus wavelength (nm) for the dispersion correction fiber according to FIG. 8 illustrating the designed location and value of the dispersion minimum.

FIG. 10 is a graph of accumulated dispersion (ps/nm) versus wavelength (nm) for the various fibers including the dispersion correction fiber of FIG. 8 and combinations of fibers in the system over an operating wavelength band.

FIG. 11 is a plot of a representative relative refractive index profile (Delta % vs. Radius (μm)) for a third embodiment of the dispersion correction fiber in accordance with the invention.

FIG. 12 is a graph of accumulated dispersion (ps/nm) versus wavelength (nm) for the various fibers including the dispersion correction fiber of FIG. 11 and combinations of fibers in the system over an operating wavelength band.

FIG. 13 is a graph of dispersion (ps/nm/km) versus wavelength (nm) for the dispersion correction fiber according to FIG. 11 illustrating the designed location and value of the dispersion minimum.

FIGS. 14-15 are graphs of refractive index profiles for a low dispersion NZDS transmission fiber and a suitable corresponding dispersion compensating fiber, respectively.

FIGS. 16-17 are graphs of refractive index profiles for a standard single mode transmission fiber and a suitable corresponding dispersion compensating fiber, respectively.

FIGS. 18-19 are graphs of refractive index profiles for a moderate dispersion NZDS transmission fiber and a suitable corresponding dispersion compensating fiber, respectively.

FIG. 20 is a block diagram of a system including more than one dispersion correction fiber according to the invention.

### DETAILED DESCRIPTION OF THE PREFERRED EMBODIMENTS

Reference will now be made in detail to the present preferred embodiment(s) of the invention, examples of which are illustrated in the accompanying drawings and tables. Whenever possible, the same reference numerals will be used throughout the drawings to refer to the same or like parts.

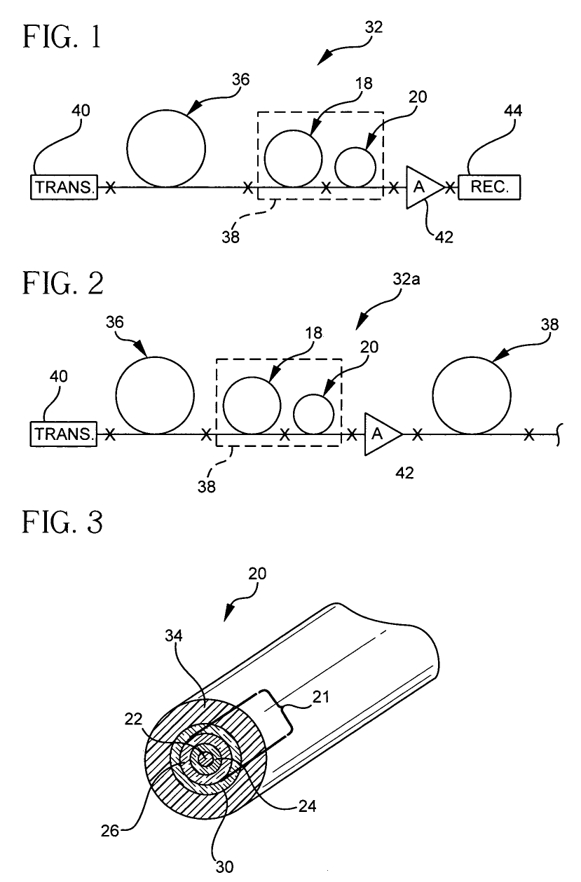

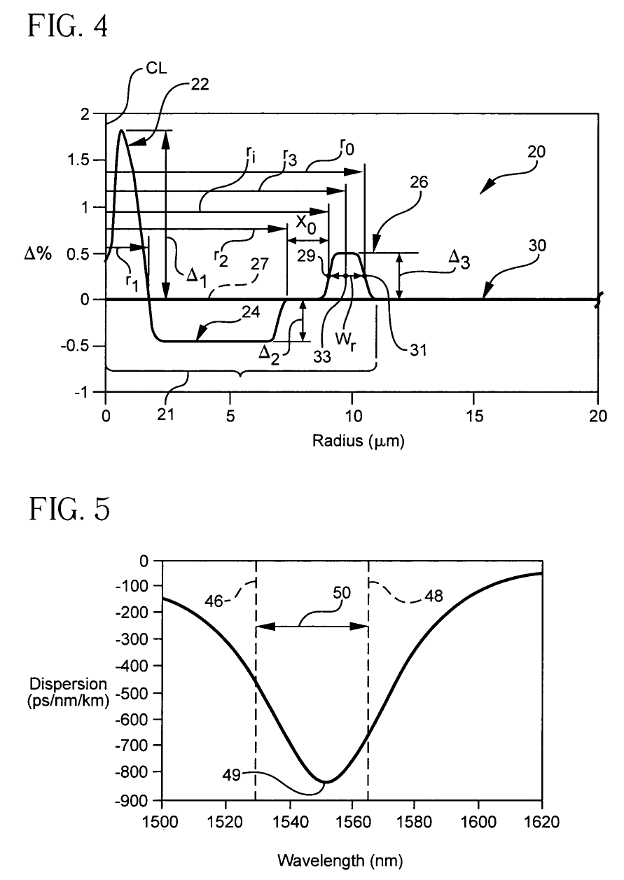

Several representative embodiments of the dispersion correction optical fibers in accordance with the present invention are shown and described with reference to FIGS. 4, 8 and 11; such fibers being designated generally throughout by the reference numeral 20. The dispersion correction fibers 20 described and disclosed herein have a segmented core structure and are intended to be used in a transmission system span (e.g., FIG. 1) and in conjunction with, and optically coupled to, a dispersion compensating fiber 18 and a transmission fiber 36. The dispersion correction fibers 20 in accordance with the invention operate to better correct for accumulated dispersion in the span and thereby provide lower residual dispersion at the end of the span across the operating wavelength band.

The structure of the correction fiber 20 preferably includes multiple core segments, in particular, preferably a central core segment, moat segment, and ring segment, which serve to collectively define a relative refractive index profile for the physical core 21 (See FIG. 3). As will become apparent herein, the relative refractive index profile of the dispersion correction fiber 20 is further described and defined with reference to the various relative refractive index percents, Δ₁, Δ₂, Δ₃, representative radii, r₁, r₂, r₃, rᵢ, rₒ, the ring width, Wr, and the ring offset, Xo. Radii for the various segments are all measured from the optical fiber's longitudinal axis center line, CL. As is conventional, the relative refractive index profile preferably does not change substantially along the longitudinal length of the fiber 20, and is preferably generally symmetrical about the fiber's centerline, CL.

Referring now to FIGS. 3-4, 8 and 11, each of the dispersion correction fibers 20 according to embodiments of the invention includes a physical refractive index profile structure including a physical core 21 and a clad layer 30; the clad layer 30 surrounding and abutting the physical core 21 and having a refractive index, n_{c}. In more detail, the segmented core 21 for the dispersion correction fibers 20 described herein preferably includes a central core segment 22 closest to the fiber's centerline, CL, and an annular moat segment 24 having a generally annular shape surrounding and contacting the central core segment 22. The fiber 20 preferably also includes an annular ring segment 26 surrounding and contacting the moat segment 24. The annular clad layer 30, which is preferably un-doped silica, preferably surrounds and abuts the ring segment 26. Clad layer 30 preferably has a nominal outer radius of about 62.5 microns although the various refractive index plots are shown truncated at about 20 microns not showing the remaining 42.5 microns (such that the general core shape may be more readily depicted). The outermost radial glass portion of clad layer 30 of the fibers 20 are preferably covered (coated) with a protective polymer coating 34 (FIG. 3), which is preferably UV curable, to a nominal outside diameter of about 250 μm. The polymer coating 34 is preferably a two-modulus acrylate coating having a softer-modulus inner primary coating and a harder-modulus secondary outer coating, as is conventional. However, it should be recognized that any suitable fiber coating may be employed.

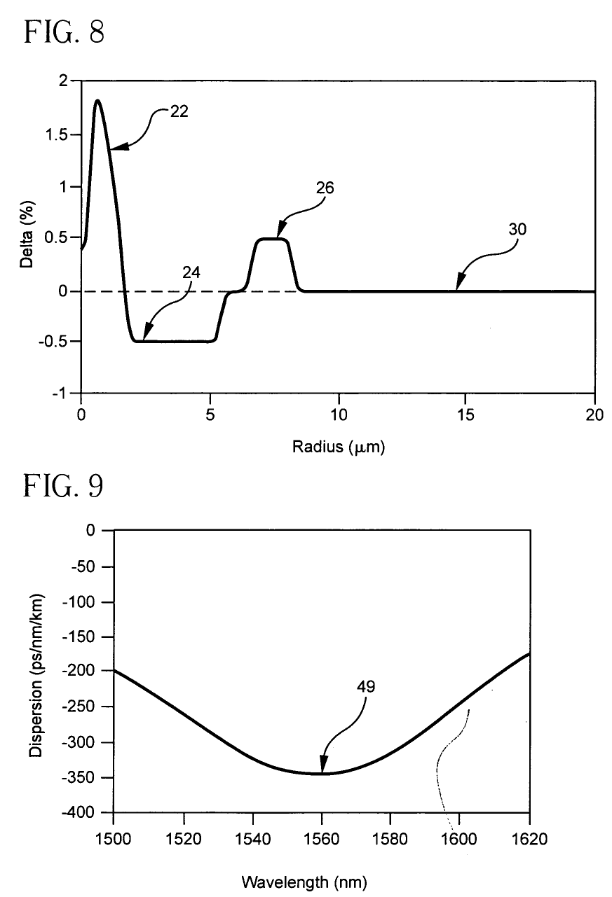

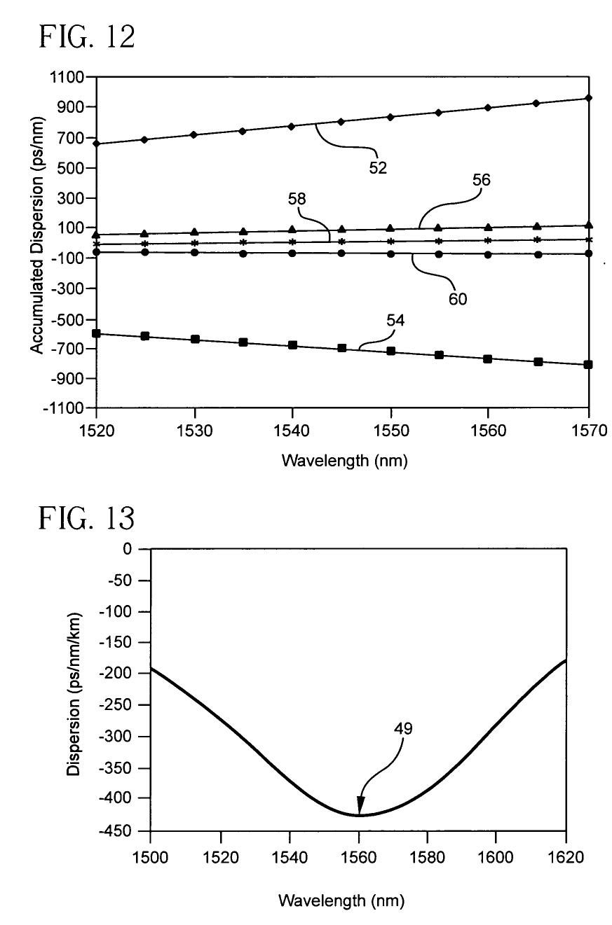

As best shown in FIG. 4, a representative relative refractive index profile for a first embodiment of dispersion correction fiber 20 according to the invention is illustrated. Variations of the profile of FIG. 4 are shown in FIGS. 8 and 11 and help fully describe the correction fibers 20 claimed herein. As will become apparent, the correction fibers 20 of FIGS. 8 and 11 are specifically designed for use with different types of transmission fibers, as compared to the embodiment of FIG. 4. In particular, the embodiment of FIG. 4 is useful for providing dispersion correction in an optical transmission system including a low dispersion NZDS transmission fiber (dispersion between about 2 and 5 ps/nm/km at 1550 nm), and a suitable dispersion compensating fiber designed for use with such low dispersion NZDSF.

Again referring to FIG. 4, relative refractive index (in percent) is charted versus the fiber radius (in microns). Further, FIG. 4 illustrates the naming conventions used throughout this specification for the deltas, Δ₁, Δ₂, Δ₃, representative radii, r₁, r₂, r₃, rₒ, rᵢ, ring width, Wr, and ring offset, Xo. The same naming conventions are used to characterize the other relative refractive index profiles for the fibers 20 shown in FIGS. 8 and 11, for example, and such conventions will not be repeated in those figures for clarity.

As best shown in FIGS. 3-4, 8 and 11, the physical core 21 for each dispersion correction fiber 20 in accordance with the invention includes a central core segment 22, an annular moat segment 24 and, in addition, preferably an offset ring segment 26. The central core segment 22 preferably exhibits a maximum relative refractive index percent, Δ₁ %, measured from the cladding reference line 27, of greater than 1.6% and less than 2.2%; and most preferably within the range from about 1.7% and 2%. Further, preferably the central core segment 22 has an alpha profile with the alpha, α, being preferably less than 10; more preferably between about 1 and 5; and most preferably about 2. As shown in the figures, the point of maximum refractive index of the central core segment 22 may be offset a predefined distance (e.g., 0.1 to 1 μm) from the fiber's centerline, CL. Preferably, the central core segment 22 exhibits an outer radius, r₁, preferably less than 3.0 μm; more preferably between 1.2 and 2.2 μm; and most preferably within the range of from about 1.5 and 2.0 μm. Outer radius, r₁, of the central core segment 22 is measured to, and defined by, the intersection of the descending leg of the relative refractive index profile of the central core segment 22 with the horizontal axis extension 27 corresponding to, and extending from, the index of the cladding layer 30, which is preferably constructed of pure silica. The refractive index profile of the central core segment 22 is preferably formed by doping pure silica (preferably during deposition) with a sufficient amount of germania such that its index of refraction is raised and, therefore, provides the desired Δ₁ %, alpha profile, and outer radius, r₁.

Preferably, an annular moat segment 24 of the dispersion correction fiber 20 surrounds, and is in contact with, the central core segment 22. The moat segment 24 preferably has a negative minimum relative refractive index percent, Δ₂ %. Δ₂ % is preferably more negative than −0.2%; more preferably more negative than −0.3%; and most preferably within the range from about −0.3 to −0.8% as measured relative to cladding 30 and line 27. Furthermore, the moat segment 24 has a width, defined herein as r₂-r₁, of preferably between about 3 to 8 μm. The bottom of the moat segment 24 preferably includes a flat portion, preferably of substantially constant index which is at least 2 μm in length. The outer radius, r₂, of the moat segment 24 is measured to, and defined as, the intersection of the moat segment 24 and the ring segment 26. In particular, the outer radius, r₂, is measured to, and defined by, the intersection of the ascending outer leg of the profile of the moat segment 24 with the horizontal axis 27 corresponding to the refractive index of the cladding layer 30. The outer radius, r₂, of the moat segment 24 is preferably located between 4.2 and 10.2 μm from the fiber's centerline, CL. Moat segment 24 is preferably formed by flood doping silica with fluorine in an amount sufficient to reduce the refractive index thereof relative to the cladding 30 in the amount to achieve the desired relative refractive index, Δ2 %, and outer radius, r₂, of the moat segment 24. U.S. Pat. No. 4,629,485 teaches one suitable method for fluorine doping an optical fiber preform. Optionally, other suitable glass modifiers other than fluorine which lower the refractive index may also be employed. The annular moat segment 24 is preferably solid glass entirely throughout and does not include any apertures formed therein along a longitudinal length thereof.

An annular ring segment 26 preferably surrounds and abuts the moat segment 24 of the dispersion correction fiber 20. The raised-index ring segment 26 preferably has a relative refractive index percent, Δ₃ %, of greater than about 0.1% and less than 1.0%; and more preferably of within the range of from about 0.4% and 0.6%. Ring segment 26 has a half-height width dimension, Wr, preferably within the range of from 0.5 μm to about 6 μm, measured from inner half-height side point 29 to the outer half-height side point 31. Ring center radius, r3, is measured from the fiber centerline, CL, to the bisection point, 33, of the width, Wr. Preferably, the radius, r3, is between 6 μm to about 12 μm; more preferably 7-11 μm. The ring width, Wr, is equal to rₒ-rᵢ, where rₒ is the dimension from the centerline, CL, to the half height point 31, and, similarly, rᵢ is the dimension from the fiber centerline, CL, to the half height point 29. The half height points, 29, 31, are measured at, and defined as, the points on the respective ascending and descending legs of the ring segment 26 where the respective delta values equal one-half of the maximum ring refractive index, Δ₃ %. The ring segment 26 is preferably formed by doping with germania sufficient to up-dope the ring segment relative to the clad layer 30 the desired amount to provide the desired ring profile shape and relative refractive index, Δ₃ %.

According to preferred embodiments the invention, the ring segment 26 is preferably offset from the edge of the moat segment 24 by a distance Xo. The offset dimension, Xo, for the dispersion compensation fiber 20 is defined by the relationship:
Xo=r₃−r₂−Wr/2
The offset, Xo, of the ring segment 26 from the edge of the moat segment 24 is a measure of the amount that the inner side point 29 of the ring segment 26 is offset from the outer edge of the moat segment 24. The offset, Xo, is preferably greater than 0.5 μm; more preferably greater than 1.0 μm; and most preferably between 0.5 and 3 μm. The size of the offset, Xo, may be varied to optimize the dispersion properties the fiber. The relative refractive index value of the portion between the outer edge of the moat and the ascending inner leg of the ring 26 is preferably equivalent to that of pure silica, but may include slight up or down doping, as well.

The clad layer 30 surrounds and abuts the ring segment 26 and has a relative refractive index percent Δ_{c} % of approximately 0%, and a nominal outer radius of about 62.5 μm. The clad layer 30 is preferably manufactured from undoped, silica glass. However, it should be understood that the clad layer 30 may be slightly up- or down-doped, as well, provided that the relative refractive index profile for the correction fiber described herein is achieved.

Each of the various embodiments of dispersion correction fiber 20 has a core/moat ratio, defined as the central core radius, r₁, divided by the outer moat radius, r₂, of preferably greater than 0.12. More preferably, the core/moat ratio is greater than 0.15; and most preferably between 0.2 and 0.3. Furthermore, preferably a moat/ring ratio for the correction fibers 20, defined as the outer moat radius, r₂, divided by the ring center radius, r₃, is greater than 0.35; more preferably is greater than 0.5; and most preferably between 0.70 and 0.85.

These dispersion correction fibers 20 according to embodiments of the present invention each exhibit the desired optical properties within an operating wavelength band such that they have excellent utility for providing dispersion correction of accumulated dispersion in an optical transmission span. In particular, such correction fibers 20 are useful in three-fiber optical transmission systems which employ a transmission fiber optically coupled to a dispersion compensating fiber in addition to the correction fiber 20 as shown and described with reference to FIGS. 1 and 2.

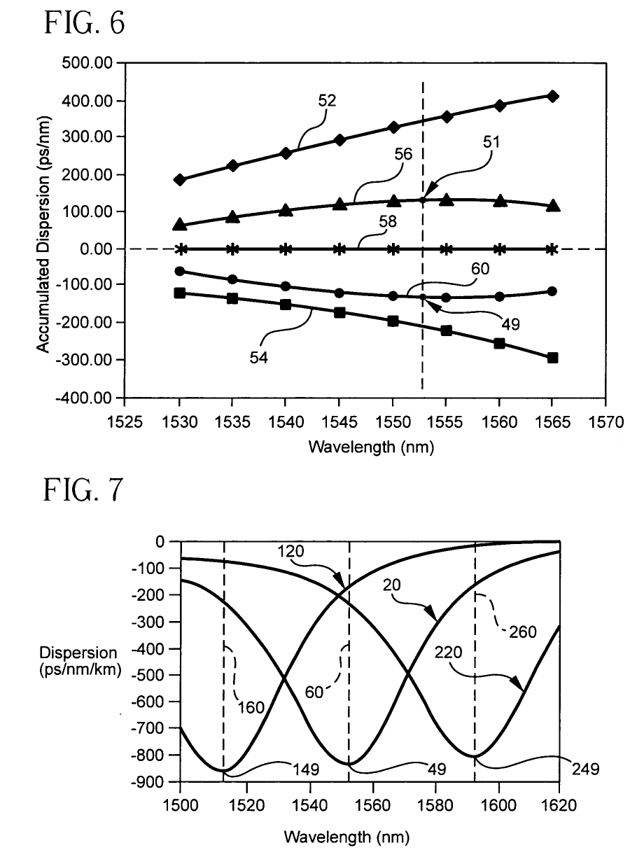

As best shown in FIGS. 5, 9 and 12, the dispersion correction fibers 20 in accordance with embodiments described herein each preferably have total dispersion minimum 49 in the LP₀₁ mode in the plot of dispersion versus wavelength. Preferably, the dispersion value at the minimum 49 is negative and less than −300 ps/nm/km at the minimum. In several embodiments, the dispersion at the minimum 49 is less than −400 ps/nm/km and greater than −1,200 ps/nm/km; more preferably less than −600 ps/nm/km; and in some embodiments less than −800 ps/nm/km. The minimum 49 is preferably located within the operating wavelength band 50 of the system. According to a preferred aspect of the invention, the minimum 49 may be located anywhere within a wavelength band between 1460 and 1625 nm. Most preferably, the minimum 49 is located within less than +/−10 nm from the location of a maxima 51 (See FIG. 6) within the operating wavelength band 50. Further, the curvature of the plot of dispersion versus wavelength (curve 60) for the dispersion correction fiber 20 is preferably substantially a mirror image (about the zero dispersion line) of the curvature of the curve 56 of the combined accumulated dispersion at the end of the span of transmission fiber 38 and the dispersion compensating fiber 18. In other words, the dispersion curvature of the correction fiber is designed to substantially mirror that of the combined accumulated dispersion of the transmission fiber plus dispersion compensating fiber. By the term “substantially mirror,” it is meant that for any wavelength within the operating wavelength band, the residual dispersion of curve 58 is less than +/−10 ps/nm per 100 km of the transmission fiber. For example, the operating wavelength band in FIG. 6 is over the C-band (1530-1565 μm). However, it should be recognized that a suitable fiber curvature could be readily designed for the L-band or the combined C+L bands, for example.

It should, therefore, be recognized that preferably the total dispersion slope at a lower end 46 of the operating wavelength band is negative, and the total dispersion slope at an upper end 48 of the operating wavelength band is positive. In the embodiment of FIG. 5, the dispersion minimum 49 is located within the wavelength band between 1530 and 1565 nm. In this embodiment, the value of total dispersion at 1550 nm at the minimum is less than −600 ps/nm/km; more preferably less than −800 ps/nm/km. To further define the curvature of the dispersion plot of the correction fiber 20, the value of dispersion at wavelengths offset +/−20 nm from the minimum 49 are preferably greater than 95% of the value at the minimum for all embodiments. For example, in FIG. 5, the dispersion values at +/−20 nm are greater than about −600 ps/nm/km, whereas the value at the minimum is less than −800 ps/nm/km.

To tune the system's residual dispersion, the location of the minimum 49 for any particular fiber design may be easily moved to a different wavelength, for example, to substantially coincide with the location of the maxima 51 for the combine accumulated dispersion within the operating wavelength band (e.g., the C-, L- or S-band). For example, FIG. 7 illustrates plots of dispersion as a function of wavelength for three different fibers (designated 20, 120, 220). The location of the minimum 149, 249 was changed (as compared to 49) by simply adjusting the radial Scaling Factor (SF) for the fibers 120, 220. For example, for fiber 220, the minimum 249 is located at the approximate center 260 (approx. 1595 nm) of the L-band operating wavelength band (1565-1625 μm). Moving the minimum 249 was achieved by radially scaling the refractive index profle of fiber 20 of FIG. 4 by a scale factor of about 1.026. Likewise, moving the minimum 149 to a wavelength 160 below the C-band (below 1525 nm) may be accomplished by radially scaling the profile of correction fiber 20 shown in FIG. 4 by a scale factor of about 0.975. Accordingly, it should be recognized that for any desired operating wavelength band, the location of the minimum may be appropriately adjusted such that it falls at the desired point within the operating wavelength band to minimize residual dispersion of the overall span.

Again referring to FIG. 5, it should be recognized that the dispersion slope is negative at a first end 46 of the operating wavelength band 50 and positive at a second end 48 of the operating wavelength band 50. In particular, the minimum 49 may be offset from the center of the operating wavelength, and in these cases, the slope at the center of the operating wavelength band may be non zero and between −1.0 ps/nm²/km and 1.0 ps/nm²/km; more preferably between −0.7 ps/nm²/km and 0.7 ps/nm²/km. The effective area of the correction fibers 20 described herein are preferably greater than or equal to about 25 μm² at the center of the operating wavelength band 50; more preferably greater than or equal to about 30 μm².

Calculated pin array bend loss exhibited by the fibers 20 is calculated to be less than about 500 dB at the center of the operating wavelength band 50; more preferably less than 400 dB. The dispersion compensating fibers 20 of the present invention further exhibit a preferred theoretical cutoff wavelength of less than about 2200 nm; more preferably less than 2000 nm. Notably, this less than stellar bend loss is very tolerable because of the short length of fiber 20 (preferably less than 0.5 km) needed in the system to correct for the accumulated dispersion therein.

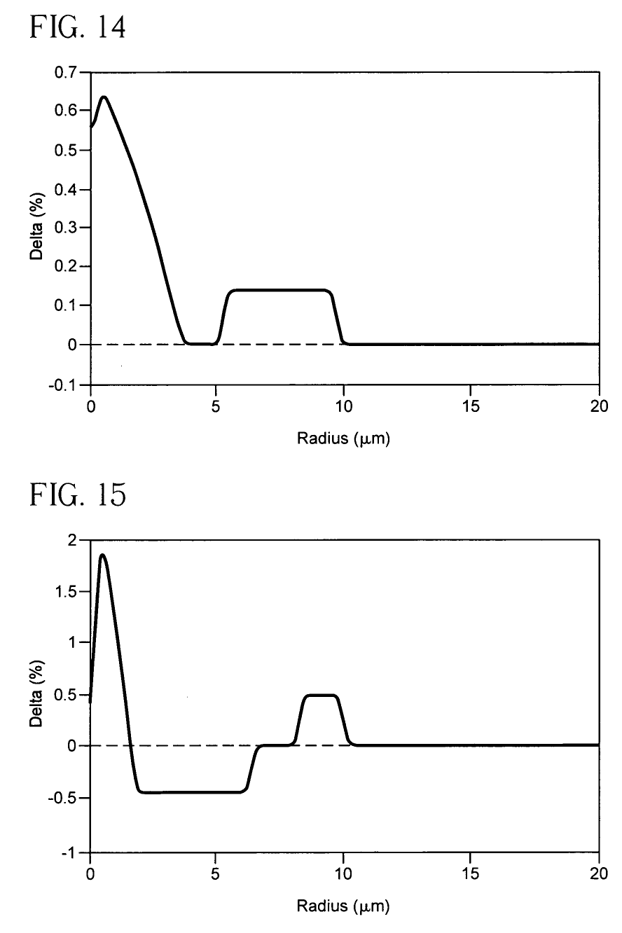

Table 1 below illustrates the modeled (calculated) optical properties for examples 1-3 of the dispersion correction fiber 20 in accordance with embodiments of the invention. Each of the fiber examples are designed to be used with a different optical transmission system. For example, the fiber shown in FIG. 4 is designed to be utilized in conjunction with a transmission system 32, 32a including a low dispersion NZDS transmission fiber 36 having dispersion between 2 and 5 ps/nm/km at 1550 nm, a dispersion slope less than 0.1 ps/nm²/km at 1550 nm, and a kappa (defined as dispersion divided by dispersion slope) between about 40-60 nm at 1550 nm. The system also includes a suitably designed dispersion compensating fiber 18 having dispersion of between about −80 and −170 ps/nm/km at 1550 nm; more preferably less than −140 ps/nm/km at 1550 nm. A further description of a low dispersion NZDS fiber is taught in U.S. Pat. No. 6,212,322 and a preferred profile is shown in FIG. 14 therefor. A further description of a suitable dispersion compensating fiber 18 for use with the FIG. 4 embodiment is described in U.S. Pat. No. 6,445,864 and U.S. Pat. No. 6,650,814 and a preferred refractive index profile is shown in FIG. 15.

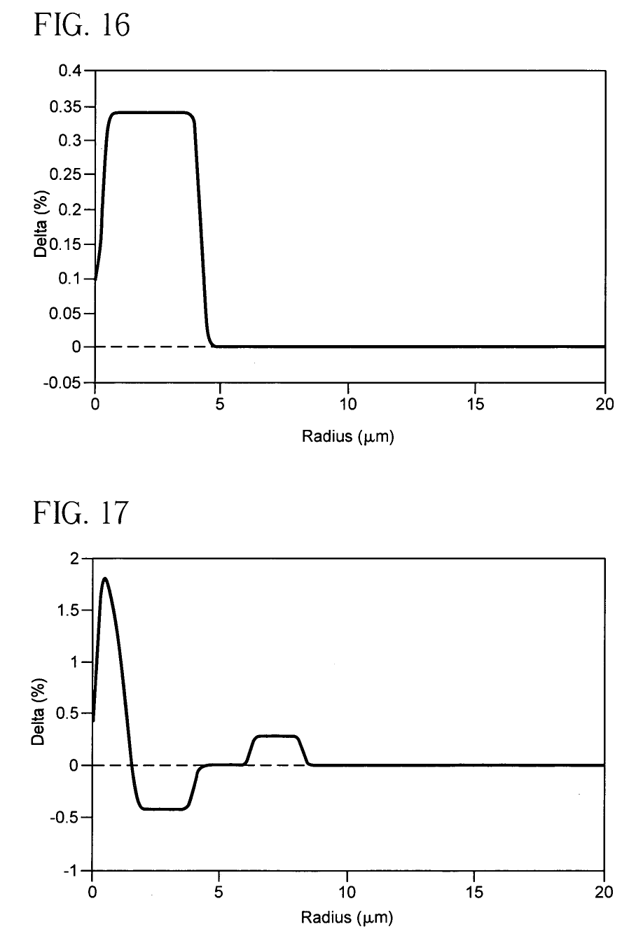

The second example of dispersion correction fiber 20 shown in FIG. 8 is designed for correcting the dispersion in a transmission system including a step-index type, standard single mode transmission fiber 38 coupled with a suitably designed dispersion compensating fiber 18. In particular, the correction fiber 20 of FIG. 8 is designed for use with a standard single mode transmission fiber 38 having dispersion between 15-20 ps/nm/km at 1550 nm, a dispersion slope less than 0.08 ps/nm²/km at 1550 nm, and kappa between 230 and 350 nm at 1550 nm. Such transmission fibers 36 preferably have a representative refractive index profile, as shown in FIG. 16, with a core delta of between about 0.3 and 0.4%, and an outer core radius of between about 4 and 6 μm. The example system including the standard single mode transmission fiber 36 and the correction fiber 20 of FIG. 8 also preferably includes a suitable dispersion compensating fiber 18 having dispersion between about −80 and −170; more preferably between −80 and −140, a dispersion slope less than −0.5 ps/nm²/km at 1550 nm, and a kappa between 230 and 350 nm at 1550 nm. One representative refractive index profile for the dispersion compensating fiber for use with a standard single mode optical fiber is shown in FIG. 17, for example. A further description of such dispersion compensating fibers for use with a standard single mode optical fibers may be found in commonly-assigned US Pat. App. No. 2003/0053780.

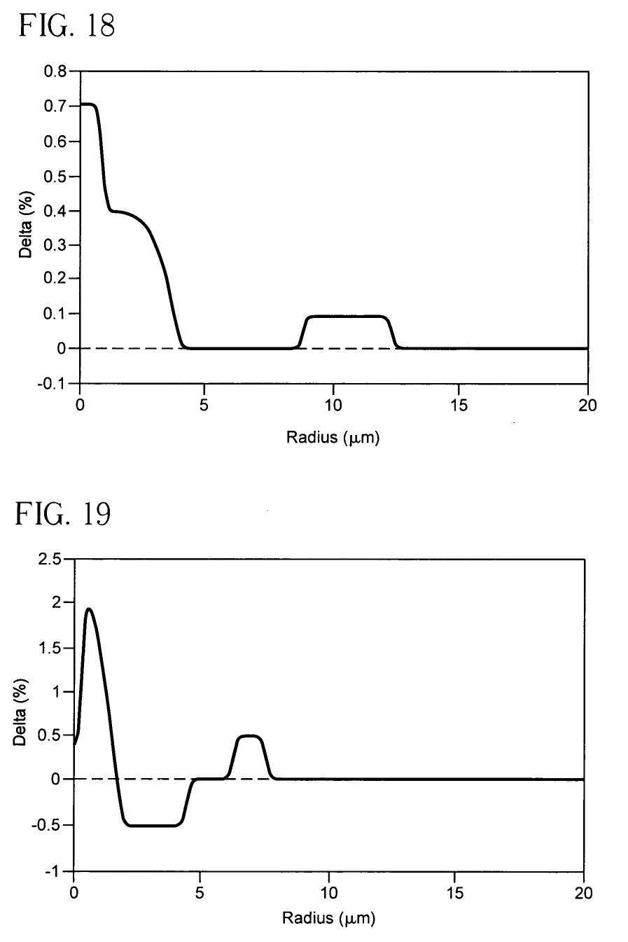

A third example of dispersion correction fiber is best shown in FIG. 11. The correction fiber is designed for use in a transmission system with a moderate dispersion NZDS transmission fiber 38, together with a suitably designed dispersion compensating fiber 18. In particular, the correction fiber 20 of FIG. 11 is designed for use with a moderate dispersion transmission fiber 38 having dispersion between 6 and 14 ps/nm/km at 1550 nm, a dispersion slope less than 0.07 ps/nm²/km at 1550 nm, and kappa between 100 and 200 nm at 1550 nm. One such transmission fiber has a representative refractive index profile, as shown in FIG. 18, and whose optical and structural parameters are described in WO 2004/011975. A further description may be found in co-filed U.S. Provisional application No. 60/______ entitled “Non-Zero Dispersion Shifted Optical Fiber” by Snigdharaj K. Mishra and filed on the same date as the instant application. The example system including the moderate dispersion NZDS transmission fiber 38 and the correction fiber 20 of FIG. 11 also preferably includes a suitable dispersion compensating fiber 18. A suitable dispersion compensating fiber 18 has dispersion between about −87 and −167 ps/nm/km at 1550 nm, a dispersion slope less than −0.30 ps/nm²/km at 1550 nm, and a kappa between 96 and 244 nm at 1550 nm. One representative refractive index profile for the dispersion compensating fiber for use with a moderate dispersion NZDS transmission fiber is shown in FIG. 19, for example. A further description of such dispersion compensating fibers may be found in commonly assigned US Pat. Pub. No. 2003/0174987, for example, or in U.S. patent application Ser. No. 10/969,929 filed Oct. 30, 2003.

TABLE 1
Optical Properties For Dispersion Correction Fibers

| | EXAMPLE # | | |
|---|---|---|---|
| | 1 | 2 | 3 |
| | FIG. # | | |
| TOTAL DISPERSION | −832 | −343 | −425 |
| (ps/nm/km) @ | | | |
| minimum | | | |
| WAVELENGTH | 1555 | 1560 | 1560 |
| (nm) @ minimum | | | |
| DISPERSION | −415 | −291 | −321 |
| (ps/nm²/km) @ | | | |
| 1530 nm | | | |
| DISPERSION | −729 | −340 | −424 |
| (ps/nm²/km) @ | | | |
| 1565 nm | | | |
| PIN ARRAY | 332 | 139 | 383 |
| BEND LOSS @ | | | |
| 1550 nm (dB) | | | |
| EFFECTIVE AREA @ | 35 | 31 | 31 |
| 1550 nm (μm²) | | | |
| λcth (nm) | 2010 | 1813 | 1612 |

Table 2 below includes examples of the dispersion correction fiber 20 in accordance with embodiments of the invention and further defines the physical structure of the relative refractive index profiles for the fibers 20 that yield optical properties within desired performance ranges.

TABLE 2
Physical Structure of Example Fibers

| | EXAMPLE # | | |
|---|---|---|---|
| | 1 | 2 | 3 |
| | FIG. # | | |
| Δ₁ (%) | 1.82 | 1.83 | 1.83 |
| r₁ (μm) | 1.60 | 1.62 | 1.60 |
| Δ₂ (%) | −0.5 | −0.5 | −0.5 |
| r₂ (μm) | 7.5 | 5.9 | 5.9 |
| Moat Width (μm) | 5.9 | 4.3 | 4.3 |
| Δ₃ (%) | 0.5 | 0.5 | 0.5 |
| r₃ (μm) | 9.8 | 7.4 | 7.9 |
| rᵢ (μm) | 9.0 | 6.6 | 7.3 |
| rₒ (μm) | 10.5 | 8.2 | 8.5 |
| Wr (μm) | 1.5 | 1.6 | 1.2 |
| XO (μm) | 1.6 | 0.7 | 0.7 |
| ALPHA | 2 | 2 | 2 |
| CORE-MOAT RATIO | 0.21 | 0.27 | 0.27 |
| MOAT/RING RATIO | 0.76 | 0.80 | 0.75 |

FIGS. 1 and 2 graphically illustrate optical transmission systems 32, 32a employing the dispersion correction fiber 20 according to the embodiments of the invention described herein. The systems 32, 32a preferably include an optical signal transmitter 40, and a transmission fiber 36 optically coupled to, and in optical communication with, the transmitter 40. The transmission fiber 36 is preferably a single mode fiber having dispersion at 1550 nm of between about 2 and 20 ps/nm/km. The transmission fiber 36 preferably has a positive total dispersion (and preferably positive total dispersion slope, as well) at the center wavelength of the operating wavelength band, for example. In particular, the transmission fiber 36 utilized in the systems 32, 32a broadly and preferably have total dispersion slope at the center of the operating wavelength band of preferably less than 0.10 ps/nm²/km. Several example systems are described herein. In particular, Table 3 below illustrates the properties of the various systems. Each system example (A, B, C) includes a different type of transmission fiber (L, S, or M), a different type of dispersion compensating fiber (I, II, or III), and a different type of dispersion correction fiber (1, 2, or 3).

TABLE 3
System Examples

| | | | | | | | RESIDUAL |
|---|---|---|---|---|---|---|---|
| | CORR | | | | | | DISPERSION |
| SYSTEM | FIBER | L_{TRANS} | L_{DCF} | L_{CORR} | DC | TRANS | (ps/nm) |
| Ex. | Ex. | (km) | (km) | (km) | FIBER | FIBER | per 100 km |
| A | 1 | 100 | 1.25 | 0.16 | I | L | +/−4.5 |
| B | 2 | 100 | 16.80 | 0.31 | II | S | +/−0.4 |
| C | 3 | 100 | 6.80 | 0.22 | III | M | +/−1.0 |

In accordance with system embodiments of the invention shown in FIGS. 1 and 2, the dispersion correction fiber 20 is optically coupled to the transmission fiber 36 and also, preferably, to a dispersion compensating fiber 18. The dispersion compensating fiber 18 has a negative dispersion (and preferably also, a negative dispersion slope) at the center of the operating wavelength band 50. One or more amplifiers (or amplifier stages) 42 may also be included in the systems 36, 36a. Representative properties of the transmission fibers, dispersion compensating fibers may be found in tables 4 and 5 below.

TABLE 4
Transmission Fiber Optical Data

| | | | DISPERSION | |
|---|---|---|---|---|
| | | DISPERSION @ | SLOPE @ | KAPPA @ |
| TRANS | | 1550 NM | 1550 NM | 1550 NM |
| FIBER | NAME | (PS/NM/KM) | (PS/NM²/KM) | (NM) |
| L | Low | 3.3 | 0.0845 | 39 |
| | Dispersion | | | |
| | NZDSF | | | |
| S | Standard | 16.6 | 0.0575 | 289 |
| | Single Mode | | | |
| | Fiber | | | |
| M | Moderate | 8.1 | 0.0535 | 152 |
| | Dispersion | | | |
| | NZDSF | | | |

The dispersion compensating fiber 18 is selected such that the total negative dispersion generated thereby is of an amount sufficient to preferably under compensate for the accumulated dispersion of the span including the transmission fiber 36 and dispersion compensating fiber 18. As shown, for example, in FIG. 6, the accumulated positive dispersion of the transmission fiber over an operating wavelength band (1530-1565 nm) is illustrated in curve 52, the negative compensating dispersion from the dispersion compensating fiber 18 is shown in curve 54, and the uncorrected combined accumulated residual dispersion is shown by line 56 (the accumulated dispersion after the span of transmission 36 and dispersion compensating fiber 18). It should be noted that the dispersion compensation is so under compensated at the end of the dispersion compensating fiber 18 that the accumulated dispersion is positive across the entire operating wavelength band.

The dispersion correction fiber 20 is added to the undercompensated span such that the accumulated dispersion at the end of the span including fibers 36, 18 and 20 is substantially compensated for, as illustrated by curve 58. The term “substantially compensate” means the dispersion compensation provided in the span by the dispersion compensating fiber 18 and correction fiber 20 is of such a magnitude that the dispersion at the end of the span (at the end of the span including the length of transmission fiber 36, length of dispersion compensating fiber 18, and length of dispersion correction fiber 20) is made to be approximately zero across the operating wavelength band 50 as best illustrated by line 58 in FIG. 6. “Substantially compensate” also includes conditions where the dispersion of the span is intentionally slightly (by as much as 5 percent of the respective value due to 100 km of transmission fiber) under compensated for or over compensated for, for example at any wavelength within the operating wavelength band 50. In particular, the curvature (second derivative of dispersion) of the dispersion correction fiber, as best shown by curve 60, is preferably selected such that the residual dispersion over the wavelength band is less than +/−10 ps/nm per 100 km of the transmission fiber 36; more preferably less than +/−5 ps/nm per 100 km. Preferably, the curvature is selected, to the extent practicable, such that it is a substantial mirror image of curve 56. In other words, the curvature shape of the concave downward curve 56 substantially mirrors that of concave upward curve 60 about the zero dispersion line. In particular, at any particular wavelength, the difference between the absolute values of corresponding points on curve 56 and curve 60 is no more than 5 ps/nm.

FIG. 1 illustrates a single fiber span of a transmission system 32 (including the transmission fiber 36, dispersion compensating fiber 18, and dispersion correction fiber 20) connected to and optically coupled between a transmitter 40 and receiver 44. In contrast to system 32, the system 32a and shown in FIG. 2 includes coupling to a repeater 42 and another length of transmission fiber 38, such that the system includes multiple spans of transmission fiber 36, 38 wherein each span preferably includes a length of the dispersion compensating fiber 18 and a length of the dispersion correction fiber 20 for substantially compensating accumulated dispersion in each respective span. The respective lengths of the fibers (L_{TRANS}, L_{DCF}, and L_{CORR}) for this and the other examples, as well as the respective calculated (modeled) performance of the systems may be found in Table 3 above. Preferably, the length of the correction fiber 20 is less than ⅕^{th} the length of the dispersion compensating fiber 18, and in some embodiments, less that 1/25^{th} the length of the dispersion compensating fiber 18. Most preferably, the length of the dispersion correction fiber in the span (and in the module) is less than 0.5 km.

In accordance with another embodiment of the invention, the dispersion correction fiber 20 preferably together with the dispersion compensating fiber 20 may be included in a dispersion compensating module 38 by winding the dispersion compensating fiber 18 and the dispersion correction fiber 20 onto one or more flanged spools or reels and/or otherwise preferably packaging the fibers inside a suitable enclosure. Optionally, the dispersion correction fiber 20 may be cabled, optically coupled to the transmission fiber and laid out lengthwise (as opposed to winding on a spool) and, therefore, may contribute to the overall span length. As shown in FIGS. 1 and 2, the Xs connote fusions splices, connectors, or other transitions optically coupling the respective system components together. It should be recognized that although the systems described herein are shown as unidirectional, that the dispersion compensating correction fiber 20 described herein may be utilized in optical systems (including combinations of transmission fiber, dispersion compensating fiber and dispersion correction fiber) that are multidirectional as well. Further, it should be recognized that the order of the respective fiber lengths may be inverted or arranged in various different orders. For example, the correction fiber 20 may be included on one end of the transmission fiber 36 and the dispersion compensating fiber 18 on the other. Likewise, the correction fiber 20 may be directly coupled to the transmission fiber 36.

By way of example, and not to be considered limiting, a very short length of less than 0.5 km of the dispersion correction fiber 20 in accordance with the invention may be employed to aid in the substantial compensation for the accumulated dispersion of approximately 100 km of the transmission fiber 36 described above. When appropriately compensated by the combination of the dispersion compensating fiber and the dispersion correction fiber, the residual dispersion amplitudes for such a system 32, 32a over an operating wavelength band (e.g., 1530 to 1565 nm) may be as low as +/−10 ps/nm or less per 100 km of the transmission fiber 36, and more preferably less than +/−5 ps/nm per 100 km of the transmission fiber 36, and in some embodiments, less than +/−2 ps/nm per 100 km of the transmission fiber 36. Table 3 above illustrates system residual dispersion amplitude over respective wavelength bands for several example transmission systems including the dispersion correction fiber 20 in accordance with embodiments of the invention. As should be apparent, the dispersion correction fibers 20 in accordance with the invention have excellent utility for improving system residual dispersion over the operating wavelength band in systems including combinations of transmission fibers 36 and dispersion compensating fibers 18.

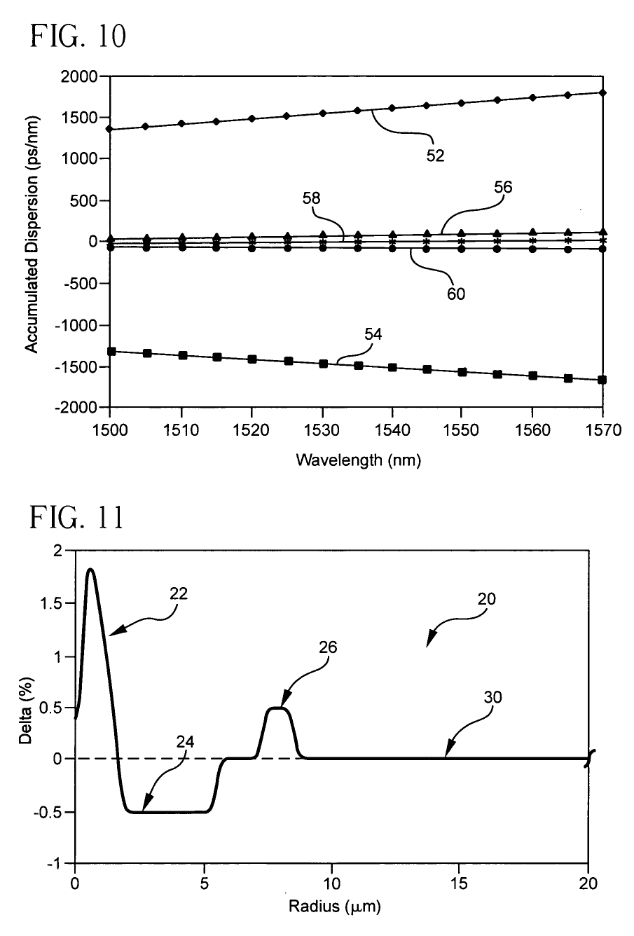

FIGS. 10 and 12 illustrate plots of calculated residual dispersion (curve 58) in ps/nm versus wavelength for various combinations of transmission fiber, dispersion compensating fiber, and dispersion correction fiber 20. Also plotted are the accumulated dispersion 52 for the transmission fiber 36, accumulated dispersion 54 for the dispersion compensating fiber 18, the accumulated dispersion 56 for the span of transmission fiber 36 and dispersion compensating fiber 18, and the accumulated dispersion for the correction fiber 60. In particular, the various transmission fibers 36 have dispersion, dispersion slope and kappa at 1550 nm as shown in Table 4. The various transmission fibers 36 are included in the span and are optically coupled to the various examples of the dispersion compensating fiber 18 and dispersion correction fibers 20. Table 5 below illustrates the properties of the various dispersion compensating fibers 36 employed in the various systems. FIGS. 14 and 15 illustrate representative refractive index profiles for the transmission fibers 36 described herein for system examples A, B, and C.

TABLE 5
Dispersion Compensating Fiber Data

| | | DISPERSION | |
|---|---|---|---|
| DISPERSION | DISPERSION @ | SLOPE @ | KAPPA @ |
| COMPENSATING | 1550 NM | 1550 NM | 1550 NM |
| FIBER | (PS/NM/KM) | (PS/NM²/KM) | (NM) |
| I | −155 | −4.09 | 38 |
| II | −92.6 | −0.3214 | 288 |
| III | −106.3 | −1.6994 | 152 |

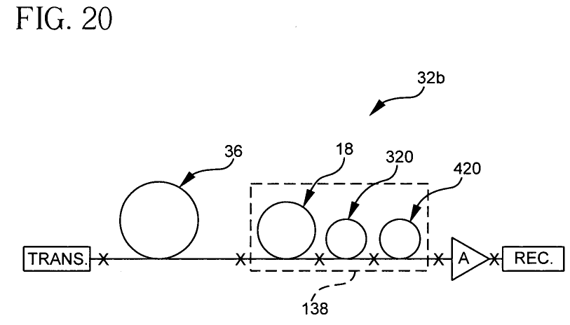

In the previous examples, a length of a single type of dispersion correction fiber is employed in the system. However, it should be recognized that systems including two or more discreet segments of the dispersion correction fiber 20 may be employed. For example, as shown in FIG. 20, more than one dispersion correction fiber 320, 420 is employed in the system 32b. In this example, several correction fibers 320, 420 are concatenated together each having slightly different properties. In particular, each correction fiber 320, 420 has a different minimum location spaced apart from each other, but with each minimum being located within the operating wavelength band. The correction fibers are, as in the previous embodiments, also optically coupled to the transmission fiber 36 and the dispersion compensating fiber 18. Moreover, the dispersion compensating 18 and correction fibers 320, 420 are preferably included within a common module 138 (for example, in a common housing). As should be recognized, more than two correction fibers may also be employed. Preferably, the fibers are connected together by splices or other suitable transition means.

Regarding fabrication methods, the dispersion correction fiber 20 may be constructed via a variety of methods including, but in no way limited to, vapor axial deposition (VAD), modified chemical vapor deposition (MCVD), plasma chemical vapor deposition (PCVD) and outside vapor deposition (OVD).

It will be apparent to those skilled in the art that various modifications and variations can be made to the present invention without departing from the scope of the invention. Thus, it is intended that the present invention cover the modifications and variations of this invention provided they come within the scope of the appended claims and their equivalents.

1. A single core dispersion correction fiber, comprising:
a refractive index profile selected to provide
a dispersion minimum having a negative total dispersion of less than −400 ps/nm/km, in the LP₀₁ mode, the dispersion minimum being located within an operating wavelength band between 1460 and 1625 nm.

2. The dispersion correction fiber of claim 1 wherein the value of total dispersion at the minimum is less than −600 ps/nm/km.

3. The dispersion correction fiber of claim 2 wherein the value of total dispersion at the minimum is less than −800 ps/nm/km.

4. The dispersion correction fiber of claim 1 wherein the value of total dispersion at the minimum is greater than −1,200 ps/nm/km.

5. The dispersion correction fiber of claim 1 wherein the dispersion minimum has a total dispersion, in the LP₀₁ mode, less than −400 ps/nm/km and greater than −1,200 ps/nm/km, the dispersion minimum being located within the wavelength band between 1530 and 1565 nm.

6. The dispersion correction fiber of claim 1 wherein the total dispersion slope at 1550 nm is between −1.0 ps/nm²/km and +1.0 ps/nm²/km.

7. The dispersion correction fiber of claim 6 wherein the total dispersion slope at a lowest wavelength of the operating wavelength band is negative and the total dispersion slope at a highest wavelength in the operating wavelength band is positive.

8. An optical fiber transmission line, comprising:
a transmission fiber having positive dispersion within the operating wavelength band;
a dispersion compensating fiber having a negative dispersion within the wavelength band optically coupled to the transmission fiber; and
the dispersion correcting fiber of claim 1 optically coupled to the dispersion compensating fiber wherein within the operating wavelength band, the transmission line exhibits a residual dispersion less than +/−10 ps/nm per 100 km span of the transmission fiber.

9. The optical fiber transmission line of claim 8 wherein the residual dispersion is less than +/−5 ps/nm per 100 km span of the transmission fiber.

10. The optical fiber transmission line of claim 9 wherein the length of the dispersion correction fiber is less than 0.5 km.

11. The optical fiber transmission line of claim 9 wherein the wavelength band is between 1530 and 1565 nm.

12. A dispersion compensating module including a dispersion compensating fiber optically coupled to the dispersion correction fiber of claim 1.

13. The dispersion correction fiber of claim 1 wherein the refractive index profile further comprises:
a central core segment with a positive relative refractive index (Δ1) and an outer core radius (r₁), and
an annular moat segment surrounding the central core segment having negative relative refractive index (Δ2) and an outer moat radius (r₂).

14. The dispersion correction fiber of claim 13 wherein
the outer core radius (r₁) is between 1.2 and 2.2 microns; and
the outer moat radius (r₂) is between 4.2 and 10.2 microns.

15. The optical fiber of claim 14 further comprising a core/moat ratio, defined as the outer core radius (r₁) divided by the outer moat radius (r₂), of greater than 0.12.

16. The optical fiber of claim 14 wherein Δ1 is greater than 1.6% and less than 2.2%.

17. The optical fiber of claim 14 wherein Δ2 is less than −0.2%.

18. A method of operating a dispersion correction fiber within an optical transmission system, the method comprising the steps of:
providing at least one dispersion correction fiber within an optical transmission system, said at least one dispersion correction fiber having a dispersion minimum in the LP₀₁ mode, and
operating the optical transmission system within an operating wavelength band wherein the dispersion minimum is positioned within the operating wavelength band.

19. The method of claim 18 with a total dispersion value at the minimum, in the LP₀₁ mode, is between −400 ps/nm/km and −1,200 ps/nm/km.

20. The method of claim 18 wherein the step of providing further includes optically coupling the dispersion correction fiber to a transmission fiber and a dispersion compensation fiber.

21. The method of claim 20 further comprising selecting lengths of the dispersion correction fiber and the dispersion compensating fiber such that within the operating wavelength band, the optical transmission system exhibits a residual dispersion less than +/−10 ps/nm per 100 km span of the transmission fiber.

22. The method of claim 21 wherein the residual dispersion is less than +/−5 ps/nm per 100 km span of the transmission fiber.

23. The method of claim 18 wherein the operating wavelength band between 1460 and 1625 nm.

24. The method of claim 19 further comprising
optically coupling the dispersion correction fiber to a transmission fiber having positive dispersion within an operating wavelength band; and
optically coupling the dispersion correction fiber to a dispersion compensating fiber having a negative dispersion within the operating wavelength band.

25. The method of claim 24 wherein the dispersion correction fiber has a total dispersion value at the minimum, in the LP₀₁ mode, of between −400 ps/nm/km and −1,200 ps/nm/km, the transmission fiber has a dispersion between 2 and 20 ps/nm/km at 1550 nm, and the dispersion compensating fiber has a dispersion of between −80 and −170 ps/nm/km at 1550 nm.

26. The method of claim 18 further comprising the step of coupling a second dispersion correction fiber to the at least one dispersion correction fiber.
